(19) United States
(12) Patent Application Publication
(10) Pub. No.: US 2014/0379144 A1
(43) Pub. Date: Dec. 25, 2014

(54) SIGNAL TRANSMISSION/RECEPTION SYSTEM IN INDUSTRIAL PLANT

(71) Applicant: KABUSHIKI KAISHA TOSHIBA, Minato-ku (JP)

(72) Inventors: Masayuki TOBOU, Kawasaki-shi (JP); Toshio SAKURAI, Nerima-ku (JP); Tadao YAMASHITA, Yokohama-shi (JP); Hiromichi YAMADA, Fuchu-shi (JP)

(73) Assignee: KABUSHIKI KAISHA TOSHIBA, Minato-ku (JP)

(21) Appl. No.: 14/306,734

(22) Filed: Jun. 17, 2014

(30) Foreign Application Priority Data
Jun. 20, 2013 (JP) 2013-130027

(51) Int. Cl. G05D 7/06

(52) U.S. Cl. CPC G05D 7/0635
USPC 700/282

(57) ABSTRACT

A system in an industrial plant which has a plurality of manual valves for controlling an amount of fluid flowing through pipes provided in an industrial plant of an embodiment includes: a measuring instrument sensor measuring a state of the plant so as to output a signal indicating measurement result; a transmitter wirelessly transmitting the measured signal; a receiver wirelessly receiving the transmitted signal; and a monitoring and controlling device collecting the received signal, in which the receivers are provided to the manual valves.

### CROSS-REFERENCE TO RELATED APPLICATION

This application is based upon and claims the benefit of priority from the prior Japanese Patent Application No. 2013-130027, filed on Jun. 20, 2013; the entire contents of which are incorporated herein by reference.

### FIELD

Embodiments described herein relate generally to a signal transmission/reception system in an industrial plant.

### BACKGROUND

In an industrial plant, a large number of measuring instruments and sensors are disposed to be utilized for monitoring and control. For example, a large-scale industrial plant has several hundreds or more of measuring instruments and sensors. Signals generated by these measuring instruments and sensors are input into a monitoring and controlling device via a laid cable. The monitoring and controlling device uses these signals for monitoring and controlling the industrial plant.

In these days, from a point of view of economic efficiency, there has been proposed a technique in which signals are transmitted/received in “wireless state” realized through streamlining conducted by reducing a cable.

A transmitting device receives signals generated by measuring instruments and sensors, and transmits the signals after converting them into radio signals. A number of the transmitting devices required in accordance with the number of measuring devices and sensors is several hundred, so that the transmitting devices are required to have an inexpensive unit cost and to be driven by small-capacity batteries. Therefore, a power of radio signal transmitted from the transmitting device is relatively weak.

Further, a receiving device (antenna) receiving a signal is required to be disposed in the relatively vicinity of the transmitting device. The limitation in terms of distance contributes to a consistency with a law stipulating radio waves or achievement of advantage in terms of security of preventing a leakage of radio transmission to the outside of plant.

Conventionally, a signal transmission/reception technique utilizing a short-distance wireless network has been proposed.

### BRIEF DESCRIPTION OF THE DRAWINGS

FIG. 1 is a plan view illustrating a first embodiment.

FIG. 2 is a diagram illustrating details of a part of the first embodiment;

FIG. 3 is a diagram illustrating an instrumentation rack.

FIG. 4A and FIG. 4B are diagrams each illustrating a comparative example for explaining the first embodiment.

FIG. 5A, FIG. 5B, and FIG. 5C are diagrams each illustrating details of a part of the first embodiment.

FIG. 6A and FIG. 6B are diagrams each illustrating details of a part of a second embodiment.

FIG. 7A and FIG. 7B are diagrams each illustrating details of a part of a third embodiment.

### DETAILED DESCRIPTION

Measuring instruments and sensors are mounted in a field area being a field environment in which facilities and devices of an industrial plant are the most congested. The field area is an area in which facilities and devices such as pumps, fans, turbines and valves, pipes, and the like are disposed in the industrial plant. To describe in an extreme manner, measuring instruments and sensors (and transmitting devices) are disposed by being surrounded by obstacles such as a large number of facilities and devices disposed in the plant.

Accordingly, in an application of short-distance wireless network, these obstacles are interposed between transmitting devices and receiving devices to hinder an arrival of signals, which causes a trouble in the transmission/reception of signals. Further, in the short-distance wireless network, a power of radio signal is weak, and it is not possible to expect a wireless reception of reflected wave reflected by the obstacles. This worsens the aforementioned problem.

In the conventional technique, when another peripheral facility becomes an obstacle of radio waves, the problem is solved by disposing a wireless sensor node (transmitting device) again to a place from which a wireless interconnecting device (receiving device) can be seen with no obstacle. However, although the conventional technique is effective as a countermeasure against a relatively small number of measuring instruments and sensors, it cannot be said that the conventional technique is not necessarily realistic in a case where several hundreds of measuring instruments and sensors are provided. For example, it is not easy to install a large number of transmitting devices and receiving devices again in a place from which the transmitting devices and the receiving devices can see each other with no obstacles.

A system of an embodiment is completed by taking such circumstances into consideration, and a signal transmission/reception system in an industrial plant capable of suitably performing a transmission/reception of radio signals in the industrial plant, an installation method of the signal transmission/reception system, and a plant are provided.

A system in an industrial plant which has a plurality of manual valves for controlling an amount of fluid flowing through pipes provided in an industrial plant of an embodiment includes: a measuring instrument sensor measuring a state of the plant so as to output a signal indicating measurement result; a transmitter wirelessly transmitting the measured signal; a receiver wirelessly receiving the transmitted signal; and a monitoring and controlling device collecting the received signal, in which the above-described object is achieved by providing the receiver to the manual valve.

### First Embodiment

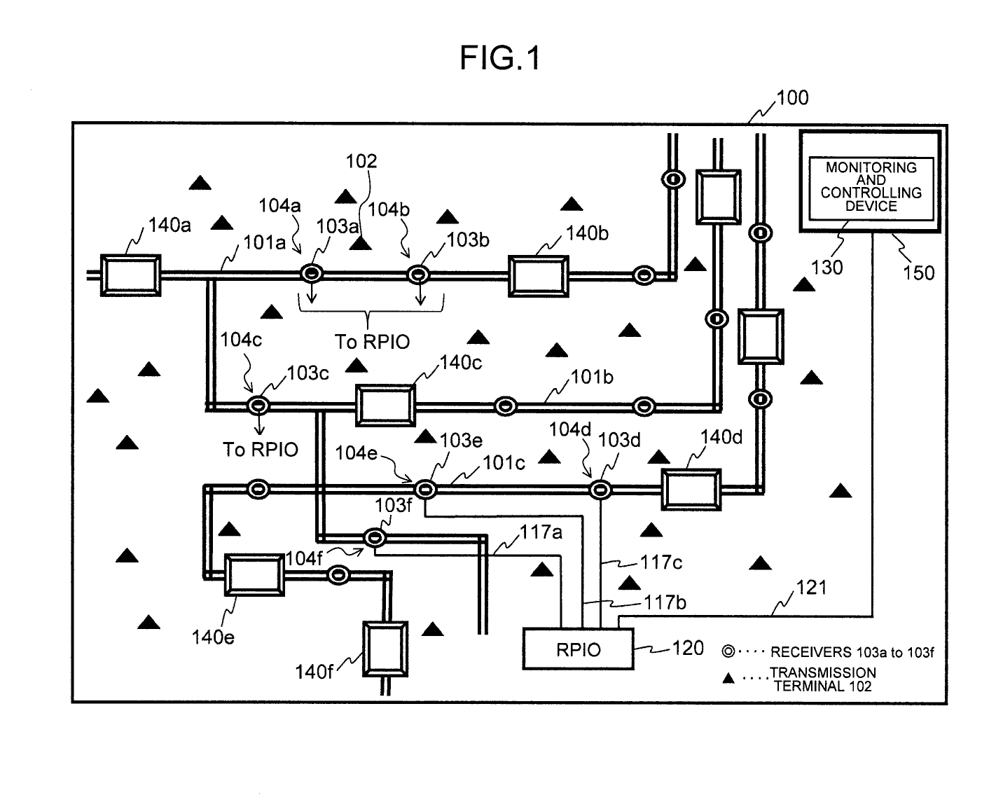

Hereinafter, embodiments will be described with reference to the drawings. FIG. 1 is a conceptual diagram illustrating an embodiment.

A signal transmission/reception system in an industrial plant using a short-distance wireless network related to a first embodiment will be described by using FIG. 1 to FIGS. 5.

FIG. 1 is a plan view when an entire plant is seen so as to look down at the entire plant from above, in which pipes 101a, 101b, 101c are laid, and auxiliary machines 140a to 140f configuring devices other than a main machine (turbine) in the plant are mutually connected by the pipes. To the pipes, manual valves 104a to 104f for controlling a fluid flowing through the pipes are provided. To the respective manual valves, later-described receivers 103a to 103f are provided.

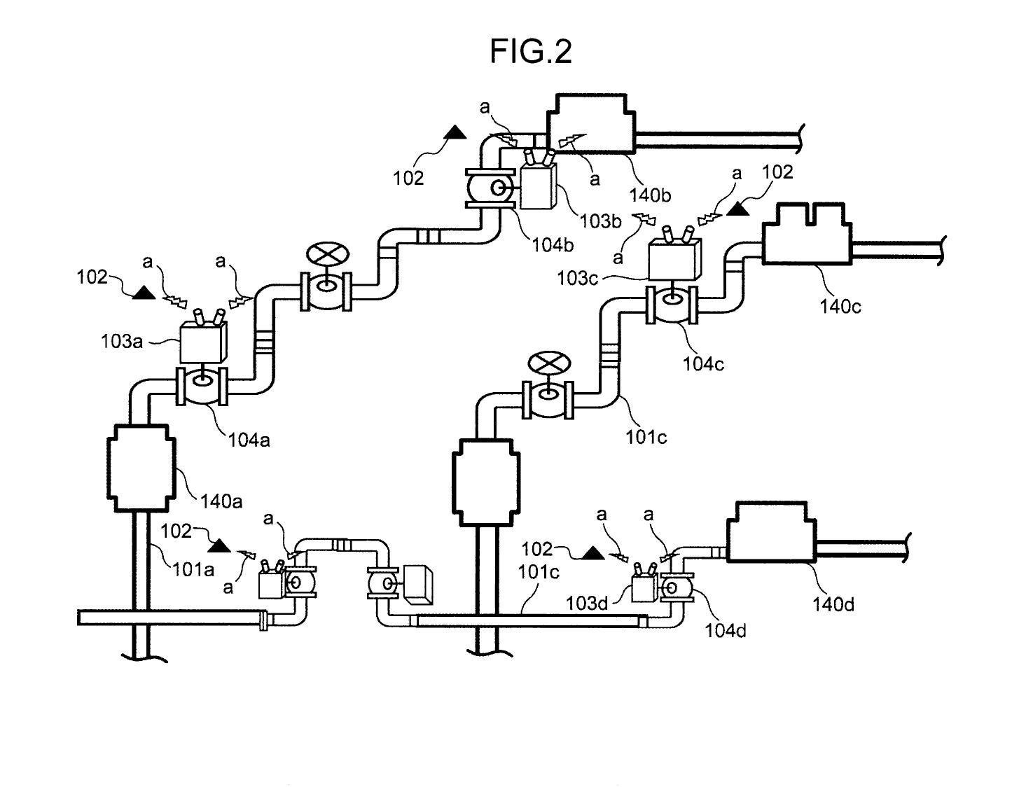

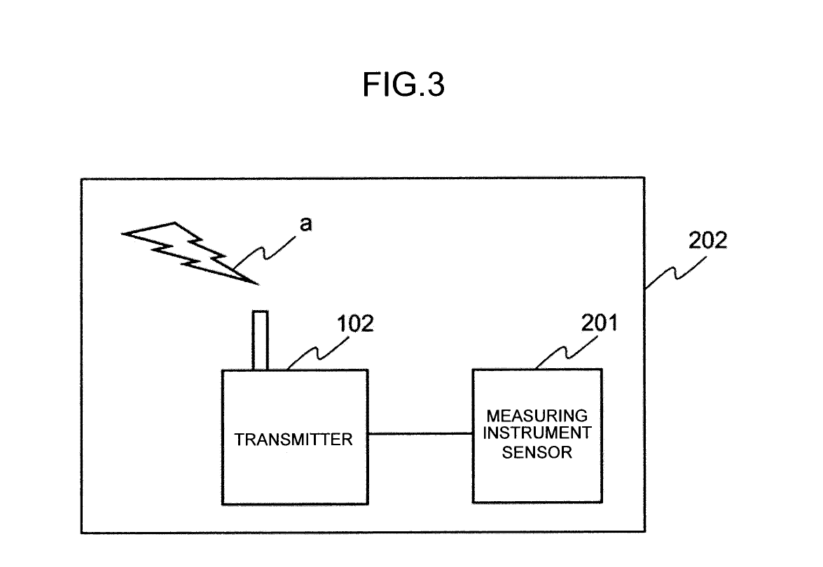

As illustrated in FIG. 2, each of the receivers 103a to 103f receives a radio signal from each of transmitters 102. As illustrated in FIG. 3, the transmitter 102 is connected to a measuring instrument sensor 201 by wire, and collects information of measuring instrument detected by the measuring instrument sensor 201 to wirelessly transmit the information as a radio signal. The transmitter 102 and the measuring instrument sensor 201 are mounted on an instrumentation rack 202. Note that there is also a case where the transmitter 102 is mounted on the measuring instrument sensor 201.

After receiving the radio signals from the transmitters 102, the receivers 103a to 103f convert the signals into transmission signals, and deliver the signals to a remote PI/O device 120 via transmission cables 117a to 117c, as illustrated in FIG. 1. The remote PI/O device 120 delivers the collected transmission signals to a monitoring and controlling device 130 via an optical cable 121. The monitoring and controlling device 130 is disposed in a central control room 150.

As illustrated in FIG. 1, a large number of transmitters each illustrated by a black triangle are disposed, other than the transmitters 102, and in like manner, a large number of receivers each illustrated by a double circle are provided to the manual valves 104, other than the receivers 103a to 103f. A radio signal transmitted by a certain transmitter is received by any one of the receivers. Further, other than the illustrated remote PI/O device 120, a plurality of remote PI/O devices (not illustrated) are disposed. The transmission cable from the receiver is connected to the nearest remote PI/O device, and connected to the monitoring and controlling device 130 by an optical communication cable via the remote PI/O device. Accordingly, pieces of information from the measuring instrument sensors collected by the receivers are gathered in the monitoring and controlling device.

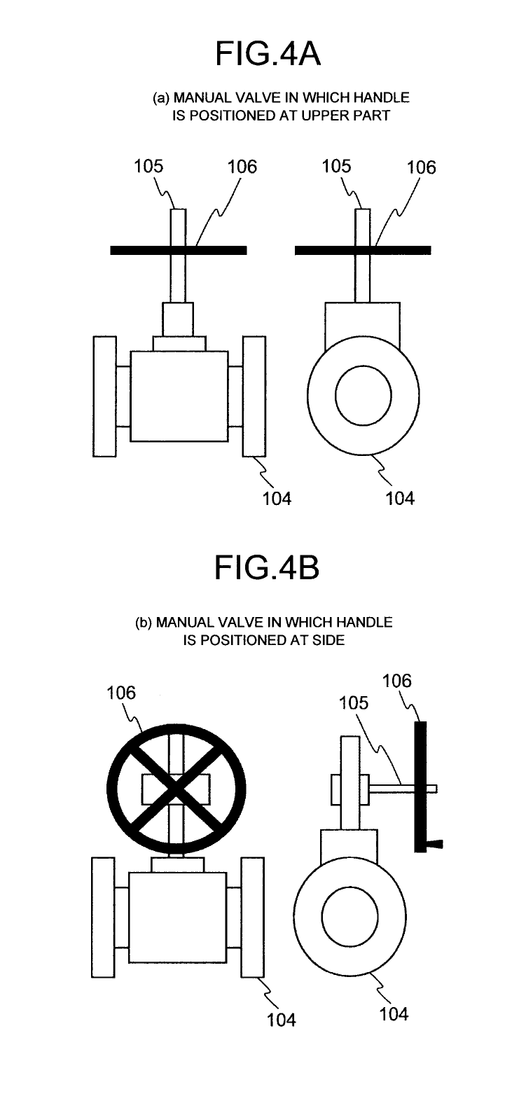

In order to illustrate a structure of attaching the receiver to the manual valve in the present embodiment, a conventional structure of manual valve will be explained based on FIG. 4A and FIG. 4B.

The manual valve 104 includes a valve rod 105, and to the valve rod 105, a handle 106 for performing an opening/closing operation of the valve is attached. There are cases where the handle 106 is positioned at an upper part of the manual valve 104 (FIG. 4A), and the handle 106 is positioned at a side part of the manual valve 104 (FIG. 4B). At a lower part in a vertical direction of the manual valve 104, a not-illustrated valve element is provided. The valve element is attached to a tip portion of the valve rod 105, and controls a flow of fluid in a pipe when the valve rod 105 moves in up and down directions in accordance with a rotation of the handle 106.

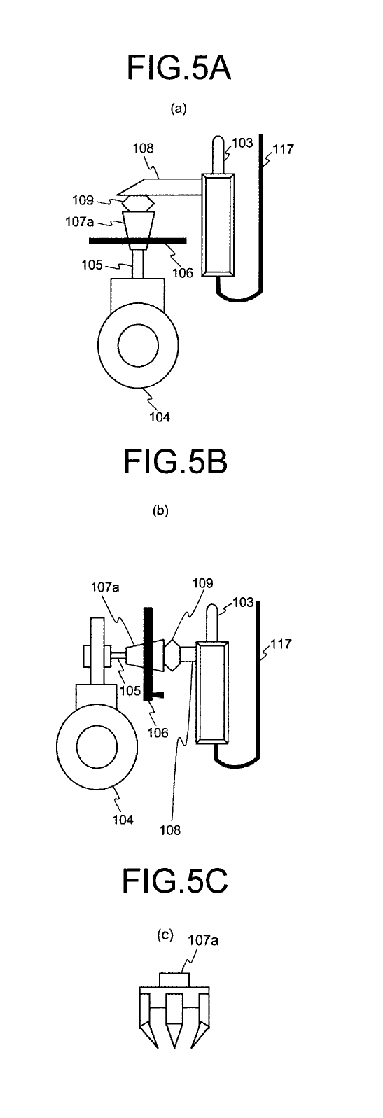

Subsequently, the receiver in the system related to the embodiment will be described by referring to FIG. 5A and FIG. 5B. As illustrated in FIG. 5A, in order to attach the receiver 103 to this handle 106, a handle adaptor 107a is arranged on the valve rod 105, on a side opposite to a side at which the valve element is provided, so as to sandwich the handle 106.

The receiver 103 is attached to the manual valve 104 via the handle adaptor 107a, a joint 109, and a shaft 108. As illustrated in FIG. 5C, the handle adaptor 107a has a tip portion formed in a claw shape, and thus is formed in a shape so as to grasp the handle 106. For this reason, the handle adaptor 107a can be easily attached/detached to/from the handle 106.

The joint 109 performs an operation to prevent the shaft 108 and the receiver 103 from being rotated even when the handle 106 is operated. Specifically, it is configured such that one end of the joint 109 is fixed to the shaft 108, and meanwhile, the other end of the joint 109 is not controlled by a rotation of the handle adaptor 107a. For example, there is provided a structure in which in a hole provided to the handle adaptor 107a, the other end of the joint 109 fitted into the hole runs idle. With such a configuration, it is designed such that the shaft 108 is not rotated even when the handle is rotated. The receiver 103 is connected by the transmission cable 117 hung down from above a space in which the plant is installed. Therefore, the receiver 103 can be disposed in a more stable state without being influenced by the rotation of the handle 106.

Note that the present embodiment can be similarly applied to, not only the structure in which the handle 106 of the manual valve 104 is positioned at the upper part of the manual valve 104 as illustrated in FIG. 4A, but also the structure in which the handle 106 is positioned at the side of the manual valve 104 as illustrated in FIG. 4B. Specifically, the handle adaptor 107a and the shaft 108 are connected with the joint 109 sandwiched therebetween, as illustrated in FIG. 5B.

When a direction of the handle 106 is changed at a time of disposing the manual valve 104 on the pipe 101, for example, in a case where, in the structure in which the handle 106 is attached to the upper part of the manual valve 104, the manual valve 104 is laid down to be disposed so that the handle 106 is positioned at the side of the manual valve 104, it is possible to select a flexible configuration in accordance with situations such that FIG. 5B is selected.

In the first embodiment of the present invention, it is designed such that the receiver is disposed on the handle 106 that performs the opening/closing operation of the manual valve. Further, it is designed such that the attaching/detaching operation of the receiver with respect to the handle 106 that performs the opening/closing operation of the manual valve is simplified.

### Second Embodiment

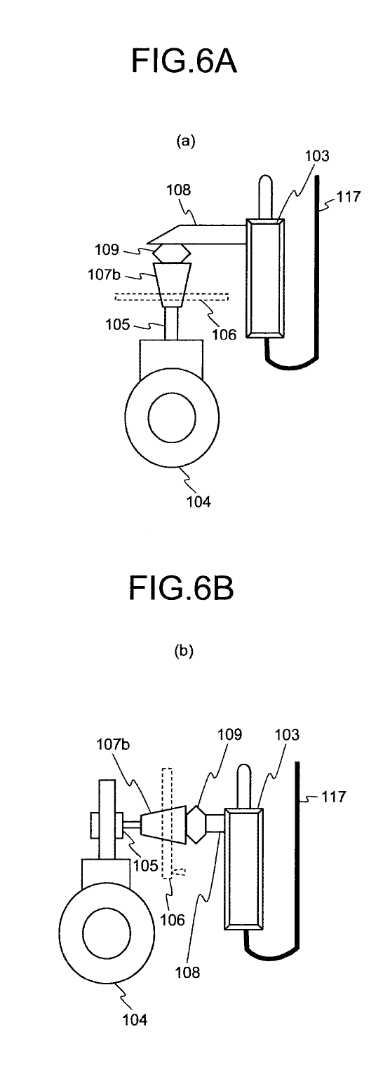

FIG. 6A and FIG. 6B illustrate a second embodiment. As illustrated in FIG. 4A and FIG. 4B, the handle 106 for the opening/closing operation is attached to the manual valve 104, and there is a case where the handle 106 is detached from the valve rod 105 of the manual valve 104 for avoiding an operation and an erroneous operation.

In this case, as illustrated in FIG. 6A and FIG. 6B, a valve rod adaptor 107b is attached to the valve rod 105 of the manual valve 104 from which the handle 106 is detached, on a side opposite to a side at which the valve element is provided, and the receiver 103 is attached via the shaft 108.

The valve rod adaptor 107b is fixed to the valve rod 105, similar to the first embodiment. Further, there is provided the joint 109 being a mechanism which prevents the receiver 103 from being rotated together with the handle 106.

The present embodiment is configured such that the receiver is disposed on the manual valve of a type in which the handle of performing the opening/closing operation of the manual valve is detached.

### Third Embodiment

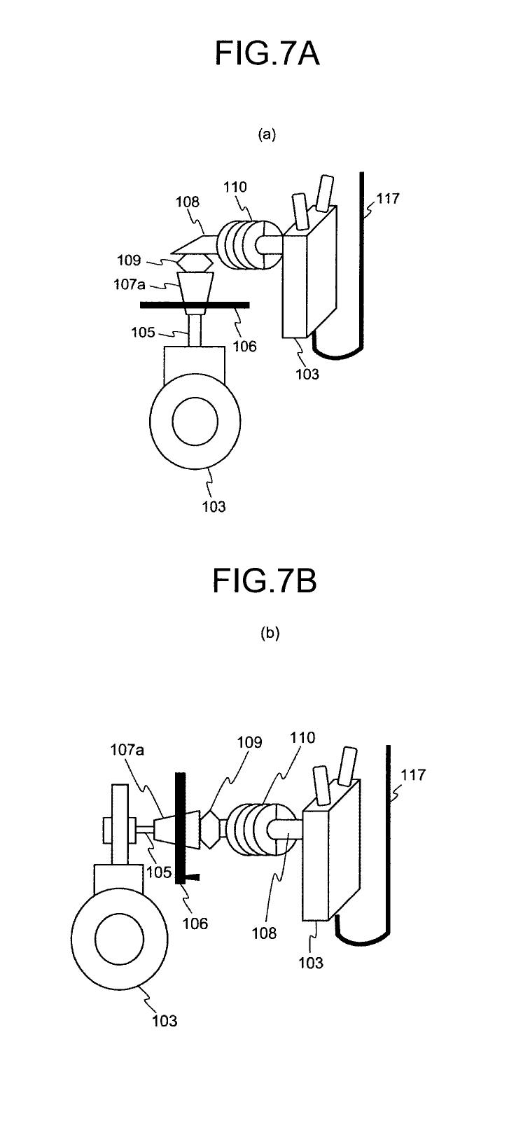

FIG. 7A and FIG. 7B illustrate a third embodiment. As illustrated in FIG. 5A and FIG. 5B, in the case of the first embodiment in which the handle 106 for opening/closing operation is arranged on the manual valve 104, the handle adaptor 107a is attached to the valve rod 105. Further, as illustrated in FIG. 6A and FIG. 6B, in the case of the second embodiment in which the handle 106 is detached, the valve rod adaptor 107b is attached to the valve rod 105. The third embodiment is the same as the above-described embodiments in a point that either of the adaptors 107a/107b is attached to one end of the shaft 108, and the receiver 103 is arranged on the other end of the shaft 108, but, it is different from the above-described embodiments in a point that a heat sink plate 110 is further arranged on the shaft 108.

The present embodiment is designed such that the heat sink plate 110 is provided to the shaft 108 on which the receiver 103 is arranged, in order to intercept a heat transfer to the receiver via the valve rod.

### Summary of Entire Embodiments

As described above, the embodiments of the present invention focus attention on the large number of manual valves disposed in the industrial plant. Generally, the manual valves are disposed on the pipes in the industrial plant, and the manual valves are opened/closed, according to need, for making a fluid (water, steam, oil, gas or the like) in the pipes to be passed or intercepted.

In the systems of the embodiments, it is configured such that the receivers are arranged on the manual valves. This makes it possible to achieve the following effects.

When compared to the number of disposed automatic valves (motor valves, hydraulic valves, pneumatic valves, electromagnetic valves) disposed in the industrial plant, the number of disposed manual valves is an overwhelmingly large number, and the large number of manual valves are widely dispersed to be disposed in the entire industrial plant. Accordingly, the manual valves are suitable locations for disposing the receivers required to equally cover the wide area.

In the manual valve, there exist the handle for conducting opening/closing of the valve, and a part with which the handle is attached. In the systems of the embodiments, the receivers are arranged on the manual valves by utilizing these parts, so that it is possible to attach the receivers by using relatively simple mechanism and structure.

Generally, it is often the case that a temperature of a fluid passing through the manual valve is a high temperature, and thus a temperature of a main body part of valve (valve element body) also becomes a high temperature. On the contrary, each of the handle on which the receiver is arranged and the part such as the valve rod for attaching the handle in the embodiments is far from the main body part of valve, and accordingly, the receiver is arranged on a place where a radiant heat radiated from the valve element body part is difficult to be received. Therefore, the manual valve is suitable for the place of disposing the receiver which is easily affected by heat.

The handle is required to be operated by a human being, so that generally, it is designed such that the handle does not receive the heat transfer from the valve element body part. Therefore, there is an advantageous point that no problem regarding heat occurs when the receiver is disposed on the handle.

The automatic valve (particularly the motor valve and the electromagnetic valve) uses electricity as a driving source, so that a problem regarding electromagnetic induction may occur with respect to the receiver. On the other hand, the manual valve causes no problem regarding electromagnetic induction with respect to the receiver, and exerts no influence on the receiver.

A frequency at which the automatic valve is operated at an intermediate opening degree is high (or a period of time during which the automatic valve is maintained at the intermediate opening degree is long), so that a fluid vibrates due to a pressure loss in front of and at a rear of a valve element, and in accordance with that, a vibration of the valve element itself is also large. This becomes a large problem when the receiver is attached. On the contrary, the manual valve is often operated in a fully-closed or fully-opened state except for a case where a maintenance of plant is conducted, so that it is not affected by a fluid almost at all, and thus is more suitable for the place of disposing the receiver which is easily affected by a vibration.

As the manual valve, a general-purpose product having a size matched to that of the manual valve and matched to a fluid condition is applied.

This means that a large number of manual valves with the same model number are disposed, or, even if the manual valves are not with the same model number, products of a series are used to realize a standard design in which components or parts are used in common.

This provides an aspect such that an attachment tool and the like for the receiver with the same design (or a small number of patterns of design) can be applied to the manual valve, for example.

According to the system of each embodiment, the receivers are arranged on the manual valves whose number of disposition is overwhelmingly larger than the number of automatic valves disposed in the industrial plant. Further, there is a tendency that the large number of manual valves are widely dispersed to be disposed in the entire industrial plant. Therefore, by providing the receivers wirelessly receiving the signals measured by the measuring instrument sensors to the manual valves, it is possible to equally cover the wide area in the industrial plant. Besides, it becomes possible to securely receive the information of the measuring instrument sensors and perform monitoring by the monitoring and controlling device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A signal transmission/reception system in an industrial plant, the industrial plant having a plurality of manual valves for controlling an amount of fluid flowing through pipes provided in the industrial plant, the signal transmission/reception system comprising:
a measuring instrument sensor configured to measure a state of the plant so as to output a signal indicating measurement result;
a transmitter configured to wirelessly transmit the measured signal;
a receiver arranged on the manual valve, the receiver wirelessly receiving the transmitted signal; and
a monitoring and controlling device configured to collect the received signal.

2. The signal transmission/reception system in the industrial plant according to claim 1,
wherein the manual valve comprises:
a valve element;
a handle; and
a valve rod converting a rotation operation of the handle into a motion of the valve element; and
the receiver is provided to the handle.

3. The signal transmission/reception system in the industrial plant according to claim 2,
wherein the receiver is provided at a position on an opposite side of a disposed position of the valve element with a position of the handle therebetween.

4. The signal transmission/reception system in the industrial plant according to claim 2,
wherein the receiver is provided in an attachable/detachable manner with respect to the handle.

5. The signal transmission/reception system in the industrial plant according to claim 1,
wherein the manual valve comprises:
a valve element;
a handle; and
a valve rod converting a rotation operation of the handle into a motion of the valve element; and
the receiver is provided to the valve rod.

6. The signal transmission/reception system in the industrial plant according to claim 5,
wherein the receiver is provided at a side opposite to a side at which the valve element is provided in the valve rod.

7. The signal transmission/reception system in the industrial plant according to claim 1, further comprising:
an adaptor mechanism attaching the receiver to the manual valve; and
a heat intercepting device intercepting a transfer of heat of the manual valve provided between the adapter mechanism and the receiver.
